(19) United States
(12) Patent Application Publication
(10) Pub. No.: US 2006/0069641 A1
(43) Pub. Date: Mar. 30, 2006

(54) Method, computer program product, and system for assuming a loan

(76) Inventors: Mark Merithew, Sterling, VA (US); Laura Hardman, Arlington, VA (US)

Correspondence Address: DICKSTEIN SHAPIRO MORIN & OSHINSKY LLP, 2101 L Street, NW, Washington, DC, 20037, US

(21) Appl. No.: 11/230,551

(22) Filed: Sep. 21, 2005

Related U.S. Application Data
(60) Provisional application No. 60/612,511, filed on Sep. 24, 2004.

(51) Int. Cl. G06Q 40/00

(52) U.S. Cl. 705/38

(57) ABSTRACT

A system, computer program product, and method that enable a parent's Federal PLUS Loan to be refinanced by the student into a new private loan product. The system includes a computer network, server, storage device and Web Site. The system, computer program product and method all allow for online application by student for the new loan, storing of the application information, electronic signature of the promissory note, electronic provision of income documentation and proof of identity, credit qualification checks completed on student by computer, creation of a new loan in the student's name, payment-in-full of the parent's PLUS loan, notification to parents of payment-in-full status, and disclosure of the new loan to the student.

### FIELD OF THE INVENTION

The present invention relates to the financial industry and particularly to a method, computer program product and system for enabling a student/child to refinance a parent's Federal PLUS loans.

### BACKGROUND OF THE INVENTION

Due to the increasing costs of college tuition, a student's parents will most likely take out Federal PLUS loans in order to help finance their child's education. Upon graduation, however, many parents expect the student to make the payments on the PLUS loan; the student may also choose to do so him/herself Currently there is no simple or convenient process or system by which a student can transfer responsibility of the loan to himself/herself

Currently, the student could take out a personal loan in the payoff amount of the PLUS loan. Most recent graduates, however, will not be able to qualify for such a loan since they have such a short credit history. Also, it would be more convenient if the student can refinance using the same financial institution as the parent did when initially getting the PLUS loan. Further, there can be tax benefits to student loans that are not available with personal loans. Alternatively, the student will make the payment on the parent's loan, while keeping the loan in the parent's name. With this solution, the obligation legally remains in the parent's name, regardless of the agreement made between the student and parents. This can prevent the student from receiving potential tax benefits, and may complicate the student's relationship with his/her parents.

There is a need for a better solution to allow the student and parent to better share the costs of college financing.

### BRIEF SUMMARY OF THE INVENTION

Embodiments of the present invention provide a system, computer program product, and method that enables a loan to be refinanced by the student into a private loan after a certain period of time has passed. The original parent borrower's PLUS Loan is paid-in-full and the student becomes the borrower of record on a new private loan.

### BRIEF DESCRIPTION OF THE DRAWINGS

FIG. 1 is a diagram of the system according to an exemplary embodiment of the invention; and

FIG. 2 is a diagram of the method according to an exemplary embodiment of the invention.

### DETAILED DESCRIPTION OF THE INVENTION

The invention relates to systems and methods for assuming loans. Specifically, embodiments of the invention describe a system, computer program product, and method for allowing a student to refinance a parent's PLUS Loan by obtaining a private student loan in the student's name.

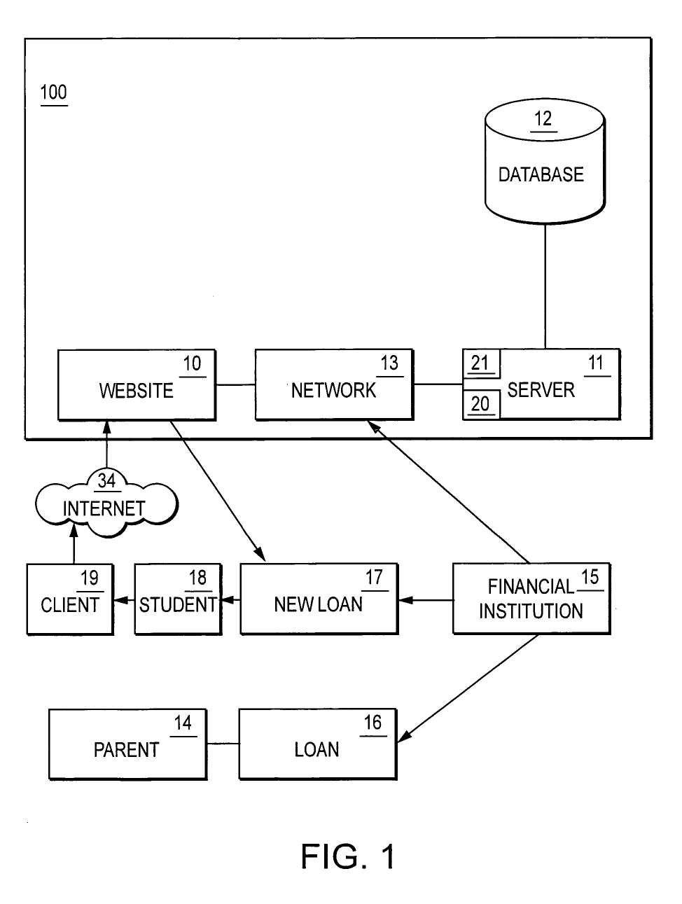

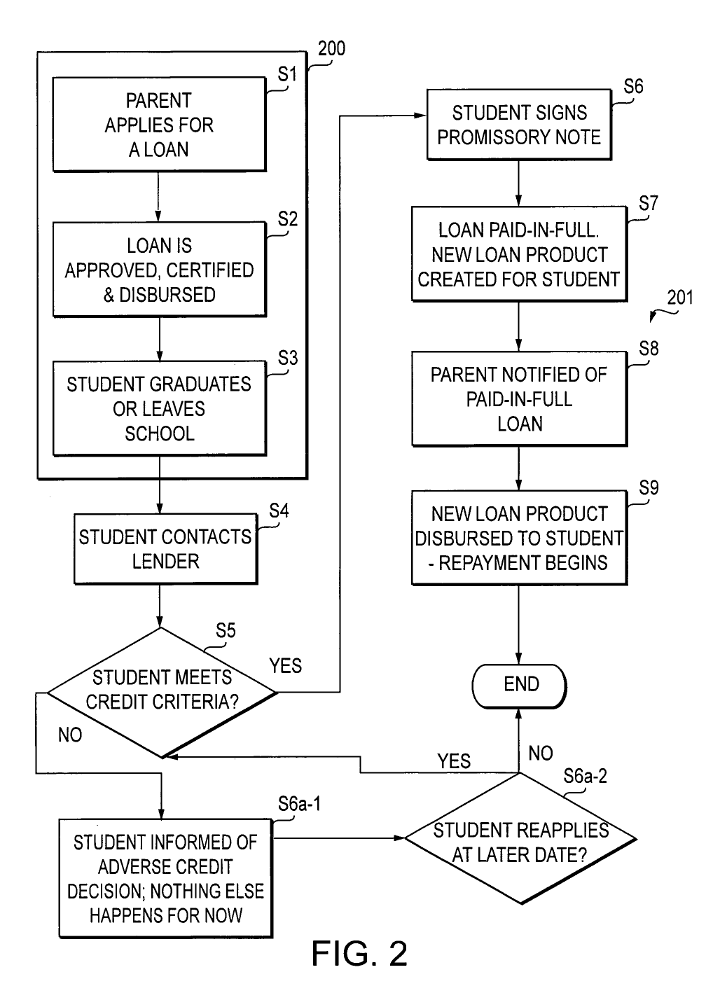

An exemplary embodiment of the invention is described below in connection with FIGS. 1 and 2.

For purposes of this disclosure, the term “parent” or “parents” means any parent, legal guardian or other person able to secure financing on behalf of a student. The term “student” means any person for whom financing is obtained by a parent.

The computer-based system 100 of the present invention, as shown in FIG. 1, includes at least one server 11 in communication with a computer network 13 and at least one database 12. In one embodiment, the system 100 includes multiple servers 11 a z900 IBM mainframe, HP Unix server, and Windows Itatium servers in communication with an extensive computer network 13 that connects locations, people, and technologies. The database stores information related to the module 20. A loan refinance module 20 runs on the server 11. At least one Web Site 10 is linked to the server 11 through the computer network 13. A Web Site 10 provides a user interface through which a user, such as a student, using a client computer 21 can interface with the system 100 over the Internet 34.

The system 100 is controlled by an entity 15 through the network 13. In the illustrated embodiment, the entity 15 is a financial institution 15 and particularly a financial institution in the business of providing educational financial aid, such as federal student loans and federal PLUS loans.

Illustratively, the loan refinance module 20 is a computer program application product embodied on a computer useable medium. The loan refinance module 20 runs on the server 11 and has access to the database 12. The module 20 allows the system 100 to carry out the method described below in connection with FIG. 2 in response to input by the student though client computer 19 and the financial institution 15 through the network 13.

Optionally, a loan management module 21 also runs on the server 11. Illustratively, the loan management module 21 is a computer program application product embodied on a computer useable medium. The loan management module 21 runs on the server 11 and has access to the database 12. The module 21 enables the system 100 to allow the student 18 to manage the new loan 17 by interfacing with the Web site 10 as described in more detail below in connection with FIG. 2.

The system 100 is configured to allow a student to apply online to refinance his/her parent's 14 loan 16. Loan 16 can be, for example, a federal PLUS loan or any other loan type. An exemplary method 201 is illustrated in FIG. 2. Steps S1-S3 are prerequisites 200 to the method 201. Specifically, the parent must have a loan 16 in order for the student to subsequently refinance the loan. The parent 14 applies for a loan 16 in step S1. The parent's loan 16 is approved, certified and disbursed in step S2. In a preferred embodiment, the parent's loan 16 was obtained from and serviced by the particular financial 15, as opposed to some other financial institution or lender.

At a time after the parent has obtained the loan, the student contacts the lender in step S4 to apply to refinance the loan 16. Optionally, the student 18 is only able to apply to refinance only after the student graduates or leaves school. It is further optional that a time period of, for example twenty-four months, or any other predetermined time frame is allowed to pass before the student 18 is permitted to apply to refinance. Allowing for graduation and time to pass, as in step S3, may allow the student 18 to get a job, be better suited to accept responsibility of the loan 16, and begin to build a credit history.

The method 201 is illustrated beginning in step S4 of FIG. 2. In step S4, the process is initiated either by the student 18 or by the student 18 and parent 14. The student 18 and parent 14 would most likely initiate the process together when it is the parent 14 who wants the student 18 to take on responsibility for the loan 16. The parent 14, however, may not initiate the process by themselves. The student 18 (and optionally, the parent 14) contacts the financial institution 15 using any communication method, including telephone, local area network (LAN) messaging, wide area network (WAN) messaging, and including through a World Wide Web-based communication. Preferably, the student 18 contacts the financial institution 15 by interfacing with the Web site 15 via client computer 19. The student 18 fills out an application form on the financial institution 15 Web site 10 and requests pre-approval for a new loan 17. In the illustrated embodiment, only the student 18 for whose education the PLUS loan 16 was taken may request to take over the parent's loan 16.

The information collected from the student 18 is stored in a database 12 within the system 100. The memory storing the database 12 is any conventionally known or used computer memory unit.

In step S5, the loan refinance module 20 analyzes the data input by the student 18 and determines whether to return a positive or negative credit decision. For example, the module 20 obtains the student's 18 credit history and calculates the student's 18 debt-to-income ratio. The module 20 then compares the information to the financial institution's 15 pre-established eligibility criteria, such as a minimum credit score and maximum debt-to-income ratio (i.e. a minimum FICO score and a debt to income ratio that is calculated by dividing the monthly debt by the current gross monthly income). If the student 18 meets the predetermined criteria, for example, the student has a credit score falling within a required range and a debt-to-income ratio falling within a required range, the module 20 issues a positive credit decision. If the student fails to meet the predetermined criteria, the module 20 issues a negative credit decision.

Depending on the criteria or as desired by the financial institution 15, the financial institution 15 can analyze all or portions of the data input by the student to arrive at a positive or negative credit decision. This can allow more complicated criteria to be readily considered. For example, weight may be given to potential future income, the value of certain of the student's assets, or other information. It is desirable to permit the financial institution 15 to consider the circumstances of the student in such instances. In this manner, the system 100 can accommodate a variety of circumstances and eligibility criteria. When the financial institution 15 arrives at a positive or negative credit decision, the financial institution 15 inputs the decision into the module 20 via the network 13.

If a positive credit decision is made, the student 18 notified on-line or via an email or letter informing him/her of the decision. Preferably, the module 20 automatically generates and sends an email upon arriving at the positive credit decision.

In step S6, the student 18 will then complete and electronically sign the promissory note by interfacing with the Web site 10 via client computer 19. The student 18 will provide income documentation and proof of identity in this step or this information will be verified using data available from the credit bureau(s). AU of this information is provided through a web-based form on the financial institution's 15 Web site 10. For example, electronic copies or electronic versions of documents can be uploaded to the system 100 and stored in the database 12 through the Web site 10. The financial institution 15 can then verify the information provided.

In step S7, upon verification of the student's 18 information, the module 20 will use the financial institution's 15 servicing transactions to pay-in-full the parent's 14 PLUS loan 16 and to issue a new loan 17 in the student's 18 name. Illustratively, the new loan 17 is a private loan, but is provided as a student loan. Accordingly, the student may be eligible for tax benefits based on the loan 17, such as a tax deduction for the interest paid on the loan 17.

In step S8, the parent 14 is notified that the loan 16 is paid-in-full. Preferably, the module 20 automatically generates and sends an email notifying the parent 14 upon payment-in-full of the loan 16.

In step S9, the student 18 is notified of the new loan 17 and repayment begins. Preferably, the module 20 automatically generates and sends an email notifying the student 18 of the new loan 17 upon payment-in-full of the parent's loan 16.

Optionally, the system 100 also allows the student 18 to manage the new loan 17 via the Web site 10. For this, an optional loan management module 21 runs on the server 11 (FIG. 1). For example, the student 18 can view the loan 17 balance, payment history, payments due, and/or make payments online. In this manner, the invention can provide a student with a convenient and comprehensive site and service for refinancing their parent's 14 loan 16, and managing their resulting new loan 17.

Referring now to step S6a-1, if the student 18 receives an adverse credit decision, he/she will receive a denial email or letter (Reg B). Preferably, the module 20 automatically generates and sends an email informing the student 18 that he/she may apply again at a later date upon arriving at the positive credit decision. If, in step S6a-2, the student 18 chooses to reapply at a later date, the method 201 begins again at step S4.

The system 100 and method 201 provide a simple and convenient way for students 18 to refinance parent loans 16. Where the financial institution 15 refinances the parent's loan 16 in the described manner, the student 18 and parent 14 are provided with various advantages over conventional methods for transferring responsibility of parent loans 16 to the student 18. For example, the system 100 provides a single, convenient interface for the student 18 to take over responsibility for the parent loan 16. Further, by refinancing the parent loan 16 with the financial institution 15, the student 18 can receive a student loan 17, which may have lower rates and tax benefits not available with a conventional personal loan.

Although the above embodiment is described in connection with a student assuming a parent's loan, the invention is not so limited. Embodiments of the invention can be used to enable a first person to assume a second person's loan. In such a case, the first person takes the place of the student 18 and the second person takes the place of the parent 14 in the above described system 100 and method 201. Further the assumed loan need not be a loan taken for educational purposes, but can instead be, for example, a car loan, a personal loan or other loan.

The processes and system described above illustrate preferred methods and a typical system of many that could be used and produced. The above description and drawings illustrate exemplary embodiments, which achieve the objects, features, and advantages of the present invention. It is not intended, however, that the present invention be strictly limited to the above-described and illustrated embodiments. Any modifications of the present invention that come within the spirit and scope of the following claims should be considered part of the present invention.

1. A computer system for refinancing parent loans, the system comprising:
a computer network;
at least one server in communication with the computer network;
at least one database in communication with the server;
a Web site in communication with the server, the Web Site providing a user interface for enabling a student to fill out an online application form for a student's loan product to payoff a parent's loan, provide information related to the financial status of the student, and electronically sign a promissory note for the student's loan; and
a loan refinance module that facilitates a decision of whether to approve or deny the student's loan to the student.

2. The computer system of claim 1, wherein the student information from the application form is stored in the database.

3. The computer system of claim 1, wherein the loan refinance module analyzes the information and compares the information to predetermined eligibility criteria.

4. The computer system of claim 3, wherein the loan refinance module automatically runs a credit bureau check based on the information.

5. The computer system of claim 1, wherein upon approval the loan refinance module initiates payment of the parent's loan in full and creates the student's loan.

6. The computer system of claim 5, wherein the loan refinance module automatically notifies the parents upon payment of the parent's loan in full and automatically notifies the student of the creation of the student's loan.

7. The computer system of claim 1, further comprising a loan management module for enabling the student to manage the new loan product.

8. The computer system of claim 1, wherein the loan is a Federal PLUS loan.

9. A computer system for financial aid institutions, the system comprising:
a computer network;
at least one server in communication with the computer network;
at least one Web site linked to the server through the computer network, the Web site providing a user interface for enabling a student to fill out an online application form for a student's loan to pay off a parent's Federal PLUS loan, electronically sign a promissory note for the loan product, and provide income documentation and proof of identity;
a database in communication with the server for storing student information from the application form, the income documentation, and the proof of identity;
a loan refinance module for enabling a computer to run a credit bureau check based on the information collected from the student in the application form, compare the student's credit qualifications to preestablished criteria, determine credit qualification based on the comparison, issue a positive or negative credit qualification decision, pay the parent's PLUS loan in full upon issuance of a positive credit qualification decision, and create the student's loan, notify the parent that the PLUS loan is paid-in-full, and notify the student of the creation of the student's loan.

10. The computer system of claim 9, further comprising a loan management module for enabling the student to manage the student's loan.

11. A method of enabling a student to refinance a parent's loan, the method comprising:
providing at least one product access Web Site located on a server in communication with a computer network that provides a user interface through which a student can fill out an online application form for a new loan product for paying off a parent's loan, electronically sign a promissory note for the new loan product;
analyzing the student's qualifications and comparing the student's qualifications to pre-established criteria; and
based on the comparison, issuing a positive or negative credit decision.

12. The method of claim 11, wherein a positive credit decision is issued if the student meets the qualifications, and wherein if a positive decision is issued the method further comprises the steps of:
creating a new loan in student's name; and
paying the parent's loan in full.

13. The method of claim 12, wherein the method further comprises the steps of:
automatically notifying the parent once the patent's loan is paid-in-full; and
automatically notifying the student once the new loan product is created.

14. A computer software program product for financial aid embodied on a computer useable medium, comprising:
a loan refinance application that runs on a server in communication with a computer network that provides a user interface through which a student can fill out an online application form for a new loan product for paying off a parent's loan, and electronically sign a promissory note for the new loan product, the loan refinance application configured to enable the server to check the student's qualifications, compare the student's qualifications to pre-established criteria, and issue a positive or negative credit decision based on the comparison.

15. The computer software program product of claim 14, wherein if credit qualifications are met the refinance application is configured to enable to server to issue a positive credit decision, and wherein once a positive credit decision is issued the loan refinance application further enables the server to:
create a new loan in student's name; and
pay the parent's loan in full.

16. The computer software program product of claim 15, wherein the loan refinance application further enables the computer to:
automatically notify the parent once the parent's loan is paid-in-full; and
automatically notify the student once the student's loan is created.

17. The computer software program product of claim 14, wherein the parent's loan is a Federal PLUS loan.

18. The computer software program product of claim 14, further comprising a loan management application that runs on a server in communication with a computer network that provides a user interface through which the student can manage the student's loan.
